(19) United States
(12) Patent Application Publication
(10) Pub. No.: US 2003/0186648 A1
(43) Pub. Date: Oct. 2, 2003

(54) Information transceiving system

(76) Inventors: Masayuki Hasegawa, Tokyo (JP); Arihiro Yoshida, Tokyo (JP)

Correspondence Address: LERNER AND GREENBERG, P.A., POST OFFICE BOX 2480, HOLLYWOOD, FL, 33022-2480, US

(21) Appl. No.: 10/272,677

(22) Filed: Oct. 17, 2002

(30) Foreign Application Priority Data
Mar. 26, 2002 (JP) 2002-084970

(51) Int. Cl. H04H 1/00

(52) U.S. Cl. 455/3.05

(57) ABSTRACT

In order to make advertising information more accessible to consumers, and thereby to expand the advertising business, an information transceiving system is provided comprising a communication terminal for receiving advertisement connection information which is used by a receiver to make a connection to advertising information and an information providing device capable of providing the advertising information. This system includes a memory for transmittably storing advertisement connection information. An advertisement connection information acquisition command transmitter transmits a command for advertisement connection information acquisition to the information providing device to acquire one or more pieces of advertisement connection information. A device acquires one or more pieces of advertisement connection information on the basis of the command for advertisement connection information acquisition from the communication terminal. A transmitter transmits the acquired advertisement connection information to the communication terminal.

### BACKGROUND OF THE INVENTION

Field of the Invention

The present invention relates to an information transceiving system in which advertising information or advertisement connection information related thereto may be acquired using a communication terminal.

Information containing advertisements has conventionally been distributed to receivers in the form of moving images, text, audio, or in arbitrary combinations thereof via television broadcasts, the Internet, or advertisement providing devices.

Taking a television broadcast as an example, an advertiser becomes a sponsor of a television program which the customer base of the products of the advertiser's company are likely to watch, and advertising information is distributed during so-called advertising breaks in the television program. Other favored examples of advertising media via which advertising information is transmitted to consumers are advertisement providing devices disposed outdoors, text broadcast providing devices in mass transit systems, such as in trains, and hanging advertisements in trains.

Such advertisements are created from a strategic viewpoint of attempting to ensure that the products of a company or a business enterprise itself remain in the memory of the consumer longer than other products or businesses, and various measures are taken to achieve this aim.

Despite the employment of advertisement methods of the aforementioned various formats, however, the reality is that consumers have a low degree of recognition of advertised products or advertisers. In particular, the majority of television commercials, except those that are rich in impact and topicality, do not typically remain in the consumers' memories. Moreover, video players are equipped with a function which cuts commercials, and thus advertisements appearing during the interim periods of a recorded television program are often cut.

As a result, telephone numbers or URLs contained in commercials are unlikely to remain in the consumer's memory. If these telephone numbers or URLs can be written down, then the commercial is effective, but writing down a telephone number or the like places a heavy burden on the consumer, and if enough time for writing down a telephone number or the like is provided in the commercial, then the costs of the commercial increase, thereby increasing the load on the advertiser.

Unlike television commercials, meanwhile, newspaper advertisements, magazine advertisements, and advertisements carried on Internet web sites are so-called “static advertising media”. The content of such static advertising media can be considered easier for consumers to remember than television commercials. However, newspapers and magazines are disposed of in a short amount of time, and Web sites must be searched for using a search engine due to the huge amounts of Web sites in existence. Such advertisements are therefore also rather unlikely to be recognized by consumers.

### SUMMARY OF THE INVENTION

It is accordingly an object of the invention to provide an information transceiving system, which overcomes the above-mentioned disadvantages of the heretofore-known devices and methods of this general type and renders advertising information more easily available to consumers, and thereby expands the advertising business.

With the foregoing and other objects in view there is provided, in accordance with the invention, an information transceiving system, comprising:

a communication terminal for receiving advertisement connection information to be used by a receiver to make a connection to advertising information;

an information providing device capable of providing the advertising information;

advertisement connection memory means for storing advertisement connection information in said communication terminal;

advertisement connection information acquisition command transmission means for transmitting a command for advertisement connection information acquisition to said information providing device in order to acquire one or more pieces of the advertisement connection information;

advertisement connection information acquisition means for acquiring one or more pieces of the advertisement connection information on the basis of the command for advertisement connection information acquisition from said communication terminal; and

advertisement connection information transmission means for transmitting the acquired advertisement connection information to said communication terminal.

In accordance with a second embodiment of the invention, there is provided an information transceiving system, comprising:

a communication terminal for receiving connection information to be used by a receiver to make a connection for retrieving information, said communication terminal including a connection memory device configured to store the connection information in said communication terminal;

an information providing device capable of providing the information;

a connection information acquisition command transmitter connected to said communication terminal and configured to transmit a command for connection information acquisition to said information providing device in order to acquire one or more pieces of the connection information;

a connection information acquisition device configured to acquire one or more pieces of the connection information on the basis of the command for connection information acquisition; and

a connection information transmitter configured to transmit the acquired connection information to said communication terminal.

In other words, the objects of the invention are achieved with an information transceiving system that comprises a communication terminal for receiving advertisement connection information which is used by a receiver to make a connection to advertising information, and an information providing device capable of providing advertising information. The novel system further comprises: advertisement connection information memory means for storing, i.e., holding advertisement connection information transmittably in the communication terminal; advertisement connection information acquisition command transmission means for transmitting a command for advertisement connection information acquisition to the information providing device in order to acquire one or more pieces of advertisement connection information; advertisement connection information acquisition means for acquiring one or more pieces of advertisement connection information on the basis of the command for advertisement connection information acquisition from the communication terminal; and advertisement connection information transmission means for transmitting the acquired advertisement connection information to the communication terminal. Thus, when a receiver finds advertising information to his/her liking from the advertising information that is on display on the information providing device or being outputted therefrom as audio information, he/she uses the communication terminal to receive advertisement connection information which is on display on the information providing device together with the advertising information or being outputted therefrom as audio information, whereby advertising information may be acquired on the basis of this advertisement connection information.

Alternatively, the information transceiving system further comprising:

advertising information holding means for holding advertising information; advertising information acquisition command transmission means for transmitting a command for advertising information acquisition to the information providing device in order to acquire advertising information relating to one or more pieces of advertisement connection information;

advertising information acquisition means for acquiring advertising information relating to the command for advertising information acquisition; and advertising information transmission means for transmitting the acquired advertising information to the communication terminal. Thus, after the receiver has acquired the advertisement connection information from the information providing device, favored advertising information can be acquired from the information providing device by transmitting the advertisement connection information to the information providing device. As a result there is no need to connect to an external device other than the information providing device in order to acquire the advertising information.

In accordance with an added feature of the invention, the advertisement connection information is included in the advertising information provided by the information providing device, and wherein the advertisement connection information holding means extract the advertisement connection information from the advertising information and hold the advertisement connection information separately from the advertising information. In other words, the information providing device extracts only the advertisement connection information from the advertising information and stores the advertisement connection information separately. As a result, the selection of advertisement connection information and transmission thereof to a receiver can be performed with ease.

In accordance with an additional feature of the invention, the advertisement connection information acquisition means enable advertisement connection information to be acquired on the condition that the command for advertisement connection information acquisition is received within a predetermined time period including the time period during which the information providing device provides advertisement connection information. Thus the receiver is only able to acquire advertisement connection information at a time close to the time at which the advertisement connection information is on display on the information providing device or being outputted as audio information therefrom. In this way the receiver can be attracted to the program information which is on display on the information providing device or being outputted as audio information therefrom, thus enhancing the effect of the advertisement.

In accordance with yet an added feature of the invention, the advertisement connection information includes a URL (uniform resource locator) which is allocated to the location at which advertising information is being held. Thus, when advertising information may be perused using the Internet, the receiver can download the advertising information from the location to which the URL is assigned (the acronym URL stands for Uniform Resource Locator and is, generally, an address in the World Wide Web of the Internet).

In accordance with an additional feature of the invention, the information transceiving system comprises a communication terminal for receiving advertisement connection information which is used by a receiver to make a connection to advertising information, an information providing device capable of providing advertising information, and a management server for managing advertising information or information relating to this advertising information. This system comprises: identifier attaching means for creating identifier-added advertisement connection information by attaching to the advertisement connection information an identifier which is unique to the location of installation of the information providing device; advertisement connection information holding means for transmittably holding identifier-added advertisement connection information; advertisement connection information acquisition command transmission means for transmitting a command for advertisement connection information acquisition to the information providing device in order to acquire one or more pieces of identifier-added advertisement connection information; advertisement connection information acquisition means for acquiring one or more pieces of identifier-added advertisement connection information on the basis of the command for advertisement connection information acquisition from the communication terminal; and advertisement connection information transmission means for transmitting the acquired identifier-added advertisement connection information to the communication terminal. Thus the location of the information providing device providing the advertising information which the receiver is viewing may be specified.

In accordance with another feature of the invention, the information transceiving system further comprises: identifier-added advertisement connection information transmission means for transmitting identifier-added advertisement connection information from the communication terminal to the management server; advertising information specifying means for specifying advertising information relating to the location of installation and the advertisement connection information on the basis of the identifier-added advertisement connection information; and advertising information transmission means for transmitting the specified advertising information to the communication terminal. Thus the receiver is able to securely acquire the advertising information that he/she has viewed by connecting to the management server after acquiring advertisement connection information from the information providing device.

In accordance with a further feature of the invention, the advertising information transmission means transmit advertising information and information concerning the reproduction start time of the advertising information to the communication terminal. Thus, when advertising information is acquired while being displayed on the information providing device or outputted therefrom as audio information, the receiver is able to display or output the advertising information on the communication terminal synchronously with the provided advertising information.

In accordance with again an added feature of the invention, identifier-added advertisement connection information is included in advertising information provided by the information providing device. Further, the advertisement connection information holding means extract identifier-added advertisement connection information from the advertising information and hold the identifier-added advertisement connection information separately from the advertising information. In other words, the information providing device extracts only identifier-added advertisement connection information from the advertising information so that this identifier-added advertisement connection information is stored separately. As a result, selection of the identifier-added advertisement connection information and transmission thereof to the receiver can be performed with ease.

In accordance with again an additional feature of the invention, the advertisement connection information acquisition means enables advertisement connection information to be acquired on the condition that the command for advertisement connection information acquisition is received within a predetermined time period including the time period during which the information providing device provides the advertisement connection information. Thus the receiver is only able to acquire advertisement connection information at a time close to the time at which the advertisement connection information is on display on the information providing device or being outputted as audio information therefrom. In this way the receiver can be attracted to the program information which is on display on the information providing device or being outputted as audio information therefrom, thus enhancing the effect of the advertisement.

In accordance with again another feature of the invention, the advertisement connection information includes a URL which is allocated to the location at which advertising information is being held. Thus, when advertising information may be perused using the Internet, the receiver can download the advertising information from the location to which the URL is assigned.

In accordance with again a further feature of the invention, a database including at least transmission processing information concerning the advertising information is stored in the management server. It is therefore possible to ascertain the amount of advertising information that has been distributed to consumers, and this information can be used by the advertising client as material by which to investigate the effectiveness of the advertisement.

In accordance with a concomitant feature of the invention, advertising information is stored in the management server. It is therefore unnecessary for the management server to acquire advertising information by accessing a further outside server.

Other features which are considered as characteristic for the invention are set forth in the appended claims.

Although the invention is illustrated and described herein as embodied in an information transceiving system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic view showing a first embodiment of an information transceiving system according to the present invention;

FIG. 2 is a block illustration explaining a sequence of data transmission and reception between a communication terminal and an information providing device in the information transceiving system of FIG. 1;

FIG. 3 is a table showing a list of titles displayed on the communication terminal in the information transceiving system of FIG. 1;

FIG. 4 is a block diagram showing the interior constitution of the communication terminal and information providing device in the information transceiving system of FIG. 1;

FIGS. 5A and 5B are two views showing, in frame format, information which is stored on an information holding part in FIG. 4; FIG. 5A illustrates an example in which a data storage region comprises a title information storing region for storing titles of advertising information created in the information holding part and a program information storing region for storing program information, and FIG. 5B illustrates an example in which an advertising information storing region for acquiring and then storing advertising information only is provided in addition to the data region in FIG. 5A;

FIG. 6 is a time-schematic diagram for explaining a method of enabling acquisition permission to be granted on the condition that advertising information is displayed and advertisement connection information acquired in synchronization in the information transceiving system of FIG. 1;

FIG. 7 is a schematic block diagram showing a second embodiment of the information transceiving system of the present invention;

FIG. 8 is a block diagram showing the interior structural-functional constitution of a communication terminal and an information providing device in the information transceiving system of FIG. 7;

FIG. 9 is a block diagram showing the interior constitution of a management server in the information transceiving system of FIG. 7;

FIG. 10A is a structural view of an address layout for a URL;

FIG. 10B is a tabular view for explaining the content of advertising information in the information transceiving system of FIG. 7; and

FIG. 11 is a schematic block diagram for explaining an application of the information transceiving system illustrated in FIG. 1.

### DESCRIPTION OF THE PREFERRED EMBODIMENTS

Embodiments of an information transceiving system of the present invention will be described below on the basis of the drawings. It will be understood that there are no particular limitations on the communication terminal as long as it is a terminal such as a portable telephone or a mobile device which is capable of performing communication.

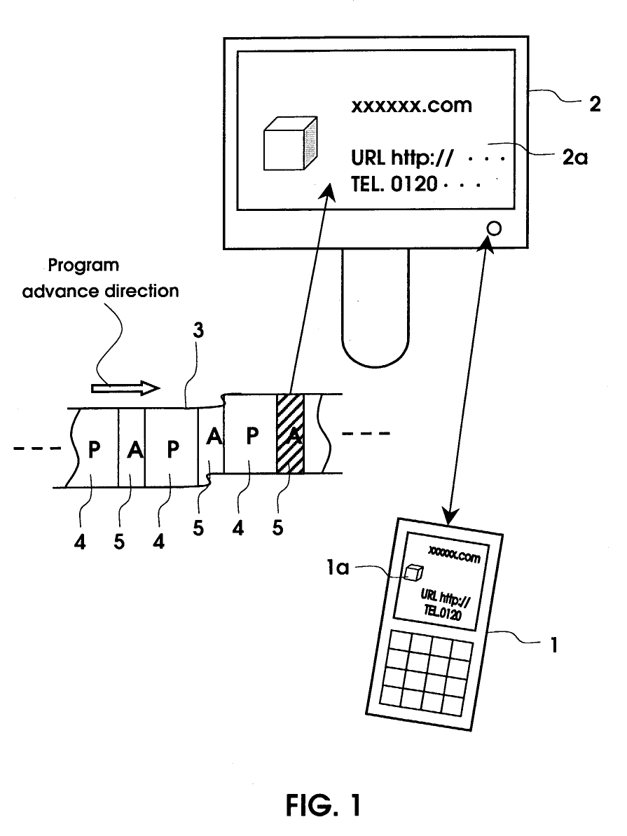

Referring now to the figures of the drawing in detail and first, particularly, to FIG. 1 thereof, there is shown a first embodiment of the information transceiving system of the present invention. This information transceiving system comprises a communication terminal 1 for receiving advertisement connection information which is used by a receiver to connect to advertising information, and an information providing device 2 which is capable of providing a receiver with advertising information (in this case, advertising information is information included within program information 3) including advertisement connection information. The term providing, as used here, does not signify data transmission to the communication terminal 1, but rather indicates an action in the information providing device 2 to cause a receiver to acknowledge advertising information visually and audibly. In this embodiment, the information providing device 2 comprises at least one of a display part for displaying projected images or an audio output part (speakers or the like) for outputting sound. It should be understood, however, that the information providing device 2 may also be a device that comprises neither a display part nor an audio output part and in which at least advertisement connection information, from among advertisement connection information and advertising information, concerning hanging advertisements, advertising magazines, and posters is transmittably stored on an IC chip. In such a case, the receiver brings the communication terminal 1 close to the information providing device 2, whereby the information stored on the IC chip can be acquired by means of an electromagnetic induction system.

The communication terminal 1 comprises a display part 1a which is capable of displaying advertising information. The information providing device 2 also comprises a display part 2a which is capable of displaying program information 3. The program information 3 is constituted by main program information 4 (indicated by “P” in the drawing) concerning television dramas and such, and advertising information 5 (indicated by “A” in the drawing) which is distributed in between the main program information 4. In this embodiment, both the main program information 4 and the advertising information 5 are moving image data. Note, however, that at least one of the main program information 4 and the advertising information 5 may be static image data. At least one of the main program information 4 and the advertising information 5 may also be audio data.

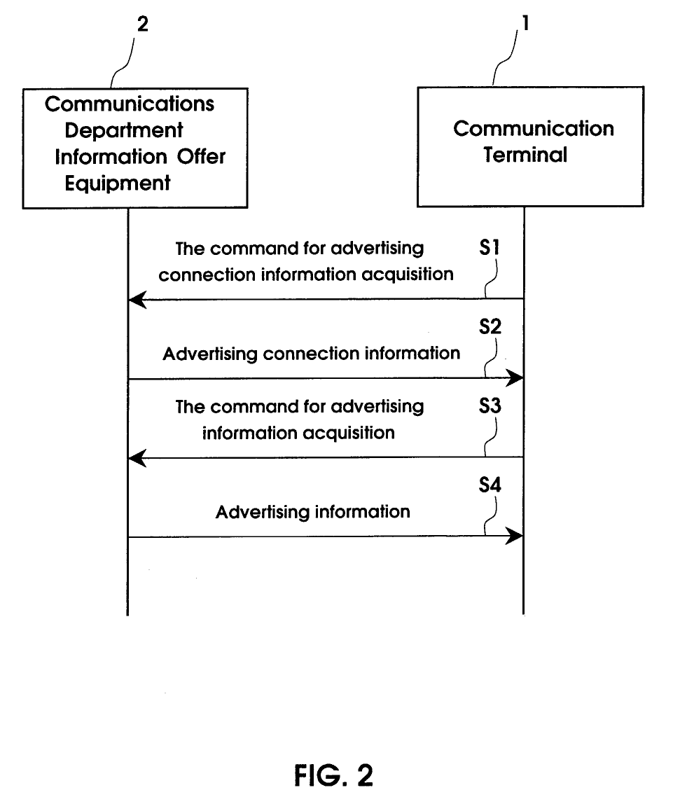

FIG. 2 is a time chart showing the communication sequence between the communication terminal 1 and the information providing device 2. A receiver views the program information 3 on the display part 2a of the information providing device 2 as the program information 3 progresses in the direction of program advance which is illustrated by the black-outlined arrow in FIG. 1. If the receiver finds advertising information 5 which is to his/her liking, the advertisement connection information of this favored advertising information 5 can be acquired through the personal communication terminal 1 of the receiver according to the sequence illustrated in FIG. 2.

In order to do so, the receiver uses the communication terminal 1 to transmit a command for advertisement connection information acquisition to the information providing device 2 in order to acquire the title information (one aspect of the advertisement connection information) of one or more pieces of advertising information 5 (step S1). Then, the information providing device 2 acquires the one or more pieces of title information from internal memory and transmits this information to the communication terminal 1 (step S2).

Then, if the receiver wishes to acquire the advertising information 5, the receiver selects the title of the favored advertising information 5 from the titles displayed on the communication terminal 1 and transmits a command for advertising information acquisition to the information providing device 2 in order to acquire the advertising information 5 which corresponds to the selected title (step S3). The information providing device 2 then acquires the advertising information 5 from internal memory (which may or may not be identical to the memory in which title information is stored) on the basis of the command received from the receiver and transmits this information to the communication terminal 1 (step S4). As a result, the receiver is able to store the favored advertising information 5 on his/her personal communication terminal 1, and may thus display advertising information 5 on the display part 1a of his/her personal communication terminal 1 at any time. Note that an information transceiving system which enables only a sequence of transmission of the command for advertisement connection information acquisition and reception of advertisement connection information (the above steps S1 and S2) to be performed between the communications terminal 1 and information providing device 2 may also be employed.

The command for advertising information acquisition here includes at least one of the following: the address of the advertising information distribution destination (IP address, telephone number, e-mail address, user ID, etc.); the date and time of the advertising information request; information concerning the position of the distribution destination; synchronous display information (information concerning a function for enabling asynchronous content to be displayed simultaneously); designation of a distribution unit for the advertising information (including an advertisement perusal list/selection of the amount of advertising information/data classification, etc.); advertising control information (advertising management number, number of components, etc.).

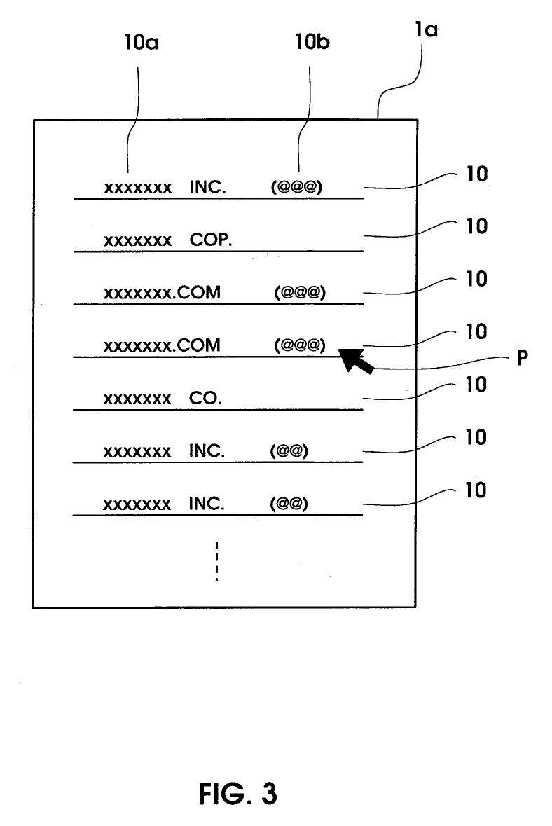

Referring now to FIG. 3, there is illustrated a view showing the conditions in which a receiver selects one title 10 from among the title information received on his/her personal communication terminal 1. The titles displayed on the display part 1a following step S2 in FIG. 2 are the titles 10 of a plurality of pieces of advertising information 5 included within the program information 3. Each title 10 is constituted by a company name 10a and a product name 10b for the product that is being advertised. Due to the fact that the advertising information 5 does not always include a product to be advertised, a title will sometimes consist of the company name 10a alone. The receiver selects one of these titles 10. The method of selection may be indication using a pointer, indication by moving a cursor, or another method. In this embodiment, selections are made by means of indication using a pointer P. Note that the title 10 may include a brand name used by a company instead of the company name 10a. The title 10 may also include both the company name 10a and a brand name.

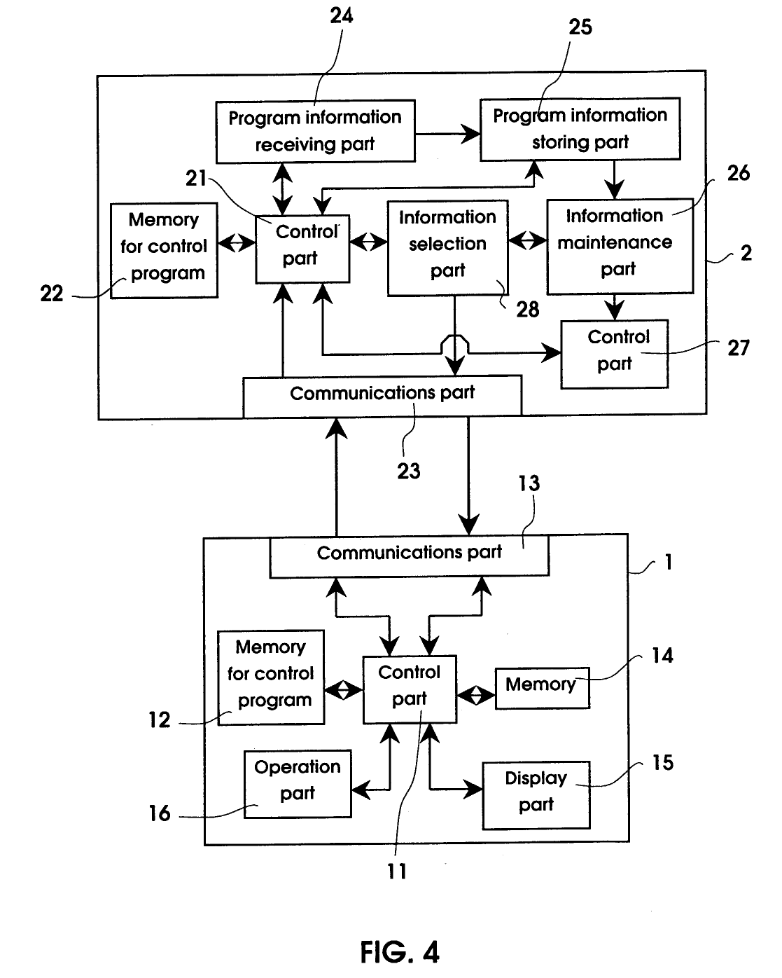

Referring now to FIG. 4, the internal structure of the communication terminal 1 and the information providing device 2 may be summarized as follows: The communication terminal 1 comprises a control part 11, also referred to as a control unit 11, a control program memory 12, a communications part 13, a memory unit 14, a display part 15, and an operation part 16. These parts or units comprise combinations of hardware and software. It will be understood, however, that the devices may be comprised of hardware alone or of software alone.

The control part 11 is a component for controlling the communication processing, display processing, and so on of the communication terminal 1. The control program memory 12 is memory for storing the control program of the control part 11. The control part 11 executes various types of control on the basis of the program stored in the control program memory 12.

The communications part 13 serves as advertisement connection information acquisition command transmission means for transmitting a command for advertisement connection information acquisition to the information providing device 2, thereby allowing a receiver to acquire advertisement connection information in order to connect to the advertising information 5, advertising information acquisition command transmission means for transmitting a command for advertising information acquisition to the information providing device 2, thereby allowing a receiver to acquire desired advertising information 5 following selection of one part of the advertisement connection information, and as a component for receiving advertisement connection information and advertising information 5 from the information providing device 2.

The memory 14 is a component for storing the advertisement connection information and advertising information 5 received from the information providing device 2. The display part 15 is a component for displaying advertisement connection information and advertising information 5 in response to an operation performed by the receiver. The operation part 16 is a component comprising a key or pointer that is operated when the receiver acquires advertisement connection information and advertising information 5 and a command transmission part for transmitting commands.

The information providing device 2, meanwhile, comprises a control part 21, a control program memory 22, a communications part 23, a program information receiving part 24, a program information storing part 25, an information holding part 26, an information output part 27, and an information selection part 28. The constitutions thereof are comprised of combinations of hardware and software. Note, however, that hardware-only constitutions or software-only constitutions are also possible.

The control part 21 is a component for controlling communication processing, display processing and so on in the information providing device 2. The control program memory 22 is memory for storing the control program of the control part 21. The control part 21 executes various types of control on the basis of the program stored in the control program memory 22.

The communications part 23 serves as advertisement connection information transmission means for transmitting advertisement connection information to the communication terminal 1, advertising information transmission means for transmitting advertising information 5 to the communication terminal 1, and as a component for receiving commands for advertisement connection information acquisition transmitted by the communication terminal 1 and commands for advertising information acquisition which are transmitted from the communication terminal 1. The program information receiving part 24 is a component for receiving program information 3 from outside. The system of reception may be either wireless or wired. The program information storing part 25 is a component for performing processing to store the received program information 3. Note that the information providing device 2 may store program information 3 in advance in the program information storing part 25 instead of receiving program information 3 from outside.

The information holding part 26 serves as advertising information holding means for holding the program information 3 by editing the advertising information 5 to enable same to be transmitted outside. More specifically, the program information 3 is divided into packets of data so that the advertising information 5 included in the program information 3 may be transmitted in packet units. The program information 3 does not necessarily have to be divided into packets of data, however. Also, only the advertising information 5 included in the program information 3 may be divided into data packets. The information holding part 26 also serves as advertisement connection information holding means for creating the titles 10 of the advertising information 5 and for holding each piece of title information which serves as the advertisement connection information separately. The processing performed by the information holding part 26 and the data stored in the information holding part 26 will be explained hereinafter.

The information output part 27 is a component for outputting the program information 3 as projected images or sound, and is constituted by a display part and speakers. The information output part 27 may consist of a display part or speakers alone. The information selection part 28 serves as advertisement connection information acquisition means for acquiring advertisement connection information from the information holding means 26 on the basis of a command for advertisement connection information acquisition from the communication terminal 1, and as advertising information acquisition means for acquiring advertising information 5 from the information holding part 26 on the basis of a command for advertising information acquisition from the communication terminal 1.

The communication between the communications part 13 and the communications part 23 is two-way infrared communication. However, this communication may be performed such that the data transmission from the communication terminal 1 to the information providing device 2 uses infrared rays and the data transmission from the information providing device 2 to the communication terminal 1 uses radio waves. Conversely, the data transmission from the communication terminal 1 to the information providing device 2 and the data transmission from the information providing device 2 to the communication terminal 1 may be performed using radio waves and infrared rays respectively. Data transmission and reception between the communication terminal 1 and the information providing device 2 may also be performed using radio waves only, and data transmission and reception between the communication terminal 1 and the information providing device 2 may also be performed by means of an electromagnetic induction system.

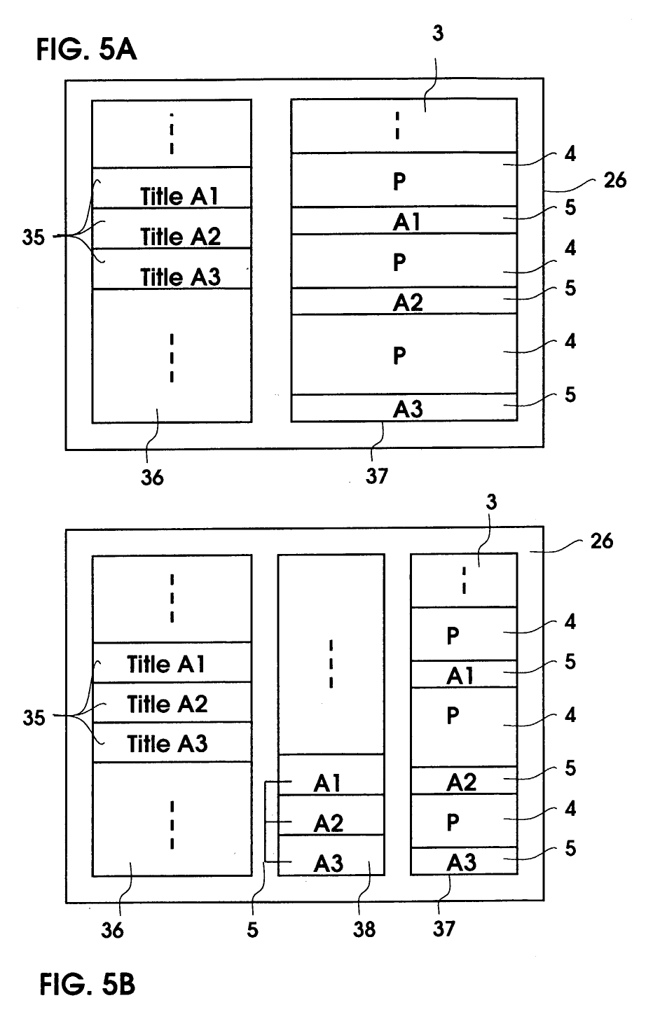

FIG. 5 shows a frame format of the information stored in the information holding part 26. FIG. 5A illustrates an example thereof in which a data storage region is comprised of a title information storing region 36 for storing title information 35 which is advertisement connection information created in the information holding part 26 and a program information storing region 37 for storing program information 3. FIG. 5B illustrates an example in which an advertising information storing region 38 which stores only the advertising information 5 is provided in addition to the data region in FIG. 5A.

In the example of FIG. 5A, the information holding part 26 reads the title information 35 (title A1, title A2, title A3, etc.) from the program information 3 in the program information storing region 37 to create the title information storing region 36 in which this title information 35 is gathered. When the information providing device 2 receives a command for advertisement connection information acquisition from the communication terminal 1, the information selection part 28 reads out the title information 35 in the title information storing region 36. The title information 35 is then transmitted to the communication terminal 1.

When the information providing device 2 receives a command for advertising information acquisition from the communication terminal 1, the information selection part 28 reads out the advertising information 5 (the advertising information corresponding to the command for advertising information acquisition) in the program information storing region 37. The advertising information 5 is then transmitted to the communication terminal 1.

In the example of FIG. 5B, on the other hand, a similar method as in FIG. 5A is employed when the information providing device 2 receives a command for advertisement connection information acquisition from the communication terminal 1, but when the information providing device 2 receives a command for advertising information acquisition from the communication terminal 1, the method is a little different from that illustrated in FIG. 5A. The information selection part 28 reads out the advertising information 5 (the advertising information corresponding to the command for advertising information acquisition) in the advertising information storage region 38. The advertising information 5 is then transmitted to the communication terminal 1. In this way, the information holding part 26 does not only store the program information 3, but also stores the title information 35 serving as the advertisement connection information, and the advertising information 5. Furthermore, the title information 35 and the advertising information 5 are related. As a result, the information selection part 28 is able to acquire the advertising information 5 on the basis of the title information 35.

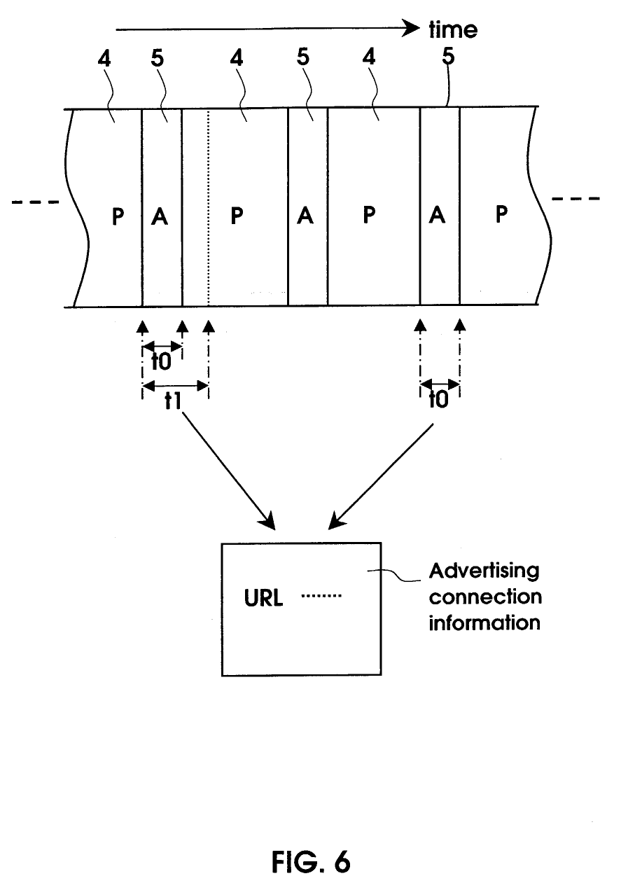

FIG. 6 is a view for explaining a modified example in which the acquisition of advertisement connection information is permitted when synchronization between the display of the advertising information 5 and an acquisition request for the related advertisement connection information has been achieved. A method other than the method explained with reference to FIGS. 2 and 3 (that is, the method of acquiring advertisement connection information regardless of the progression of the program information 3) may be employed in which the acquisition of advertisement connection information is permitted only when a command for advertisement connection information acquisition is received near the time at which the related advertising information 5 is displayed. This method will hereinafter be referred to as “synchronous acquisition”. This synchronous acquisition may be realized as the following types of information acquisition methods. A first acquisition method is a method for enabling the acquisition of advertisement connection information when the information providing device 2 is accessed at the point when the advertisement connection information is displayed within the advertising information 5. Note that advertisement connection information does not necessarily have to be displayed within the advertising information 5. A second acquisition method is a method for enabling the acquisition of both displayed advertisement connection information and non-displayed advertisement connection information together. A third acquisition method is a method substantially identical to the second acquisition method, in which regardless of whether the advertisement connection information on display is displayed on the communication terminal 1 and the remaining advertisement connection information is stored in memory, or all of the acquired advertisement connection information is displayed on the communication terminal 1, the advertisement connection information which was on display is displayed after being marked. Here, an explanation will be provided with the first acquisition method as an example.

As is illustrated in FIG. 6, the display time of the advertising information 5 is set at t0. If a command for advertisement connection information acquisition is received from the communication terminal 1 during this time t0, the information selection part 28 shown in FIG. 4 acquires the advertisement connection information of the advertising information 5 on display from the information holding part 26. If display is already over, the information holding part 26 renders reception impermissible and the advertisement connection information cannot be acquired from the information holding part 26.

As is shown in FIG. 6, the reference time of the information holding part 26 at which reception is permissible may be set at a predetermined time t1 which is a little longer than the display time t0. In other words, the information holding part 26 may permit the transmission of the advertisement connection information of the advertising information 5 even when the display of the advertising information 5 is over as long as a request therefor is received within the predetermined time t1 following the start of display. Note that permission to transmit advertisement connection information may depend upon the control of the information selection part 28 instead of depending on the control of the information holding part 26.

It should be understood that advertisement connection information is not limited to title information, but may also be an advertiser's URL or telephone number which is carried in the advertising information 5. If the advertising information 5 is stored in the storage location of the related URL, the advertisement connection information may be set as connection information which is connectable to the advertising information 5. Further, the synchronous acquisition described with reference to FIG. 6 may be employed when the advertising information 5 is received from the information providing device 2. In other words, provision may be made such that the advertising information 5 is only transmitted from the information providing device 2 to the communication terminal 1 when a command for advertising information acquisition has been received from the communication terminal 1 during the display time t0 or the predetermined time t1.

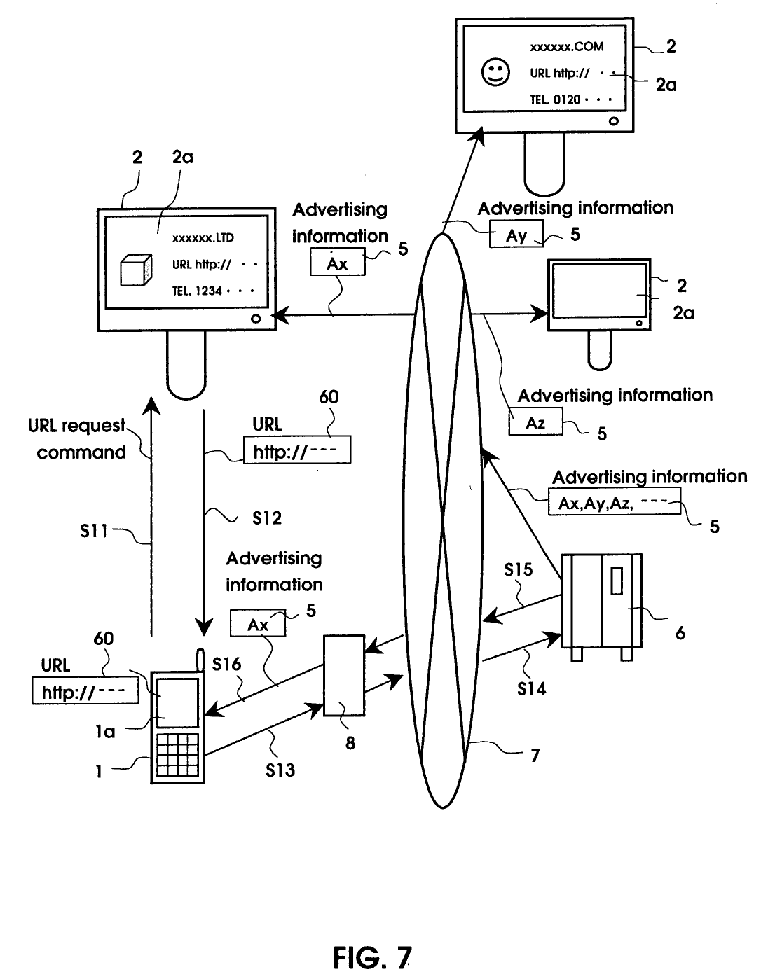

Reference will now be had to a second embodiment of the invention. The description thereof will commence with a description of FIG. 7.

FIG. 7 is a view showing a second embodiment of the information transceiving system of the present invention. This information transceiving system comprises a communication terminal 1 which is used for receiving advertisement connection information which allows a receiver to connect to advertising information 5, an information providing device 2 for providing the receiver with visual and auditory advertising information 5 including advertisement connection information, a management server 6 which stores the advertising information 5 and is capable of transmitting this advertising information 5 to both the information providing device 2 and the communication terminal 1, the Internet 7 which serves as a type of communications network, and a base station 8 connecting the communication terminal 1 and the Internet 7.

The communication terminal 1 comprises a display part 1a which is capable of displaying the advertising information 5. The information providing device 2 also comprises a display part 2a which is capable of displaying the advertising information 5. In this embodiment, the information displayed on the information providing device 2 includes only the advertising information 5 and not the main program information 4. Note, however, that the information displayed on the information providing device 2 may be program information 3 comprised of main program information 4 for television drama or the like and advertising information 5, as in the first embodiment.

A URL (this being one example of advertisement connection information) 60 in which advertising information 5 is stored is included in the advertising information 5. As will be described below, the URL 60 comprises an identification part which differs in accordance with the installation locations of the information providing devices 2 which are disposed in various locations. The URL 60 does not have to be included in the advertising information 5, however.

The data transmission and reception between the communication terminal 1 and the information providing device 2 is conducted by means of infrared communication. The data transmission from the management server 6 to the information providing device 2 and the data transmission and reception between the communication terminal 1 and the management server 6 are conducted via the Internet 7. In this embodiment, the communication between the communication terminal 1 and the base station 8 is wireless, but may be wired.

The management server 6 stores different advertising information 5 according to the installation location of the information providing device 2, and transmits this advertising information 5 to the information providing devices 2 in all locations at either fixed or irregular intervals. As is illustrated in FIG. 7, in this embodiment the advertising information (Ax) 5, the advertising information (Ay) 5, and the advertising information (Az) 5 are respectively transmitted to information providing devices 2 installed in different locations. It is not, however, necessary to perform processing to transmit and update advertising information 5 from the management server 6 to the information providing devices 2 in all locations. Different advertising information 5 may be stored in advance in the information providing devices 2 in all locations. The advertising information 5 may also be transmitted and updated at all times, or may be transmitted and updated all at once.

The management server 6 may also transmit the same advertising information 5 as the advertising information (Ax, Ay, Az) 5 that is displayed on the information providing device 2 to the communication terminal 1, or other advertising information (Ax′, Ay′, Az′) 5 may be transmitted to the communication terminal 1. When the advertising information (Ax, Ay, Az) 5 which is displayed on the information providing device 2 is a commercial for a certain product, for example, the receiver may access the management server 6 and acquire advertising information (Ax′, Ay′, Az′) 5 as detailed information about the product or events relating to the product. Explanation will be provided hereinafter using the example in which the advertising information 5 displayed on the information providing device 2 and the advertising information 5 which is transmitted from the management server 6 to the communication terminal 1 are the same.

Advertising information (Ax′, Ay′, Az′) 5 may also be stored on an advertisement distribution server other than the management server 6, whereby the communication terminal 1 acquires this advertising information (Ax′, Ay′, Az′) 5 by accessing the advertisement distribution server. In other words, the management server 6 may be broadly interpreted to include an advertisement distribution server.

The sequence up to the acquisition of the advertising information 5 by the receiver will now be explained. First, the receiver views the advertising information 5 displayed on the display part 2a of the information providing device 2, and if the receiver finds advertising information (for example Ax) 5 to his/her liking, he/she transmits a command for advertisement connection information acquisition (a URL request command in the drawing) to the information providing device 2 using his/her personal communication terminal 1 in order to acquire the URL 60 which serves as advertisement connection information included in the favored advertising information (Ax) 5 (step S11).

The information providing device 2 then transmits the URL 60 included in the advertising information (Ax) 5 which is on display to the communication terminal 1 (step S12). Next, the receiver displays the acquired URL 60 on the display part 1a of the communication terminal 1 and transmits a command for advertising information acquisition to the management server 6 in order to download the advertising information (Ax) 5 stored in the location allocated to the URL 60 (step S13). The management server 6 to which a connection has been made from the communication terminal 1 via the base station 8 and the Internet 7 receives this command (step S14).

The management server 6 then transmits the advertising information (Ax) 5 which is stored in the URL 60 to the communication terminal 1 (step S15). The communication terminal 1 receives this advertising information (Ax) 5 via the Internet 7 and the base station 8 (step S16). Thus the receiver can store the favored advertising information (Ax) 5 in his/her personal communication terminal 1 and display this advertising information (Ax) 5 on the display part 1a of his/her personal communication terminal 1 at any time. The advertising information (Ax) 5 acquired from the communication terminal 1 may also be reproduced in synchronization with the advertising information (Ax) 5 provided by the information providing device 2. This function is performed in accordance with processing by the synchronous output part 88 to be explained below.

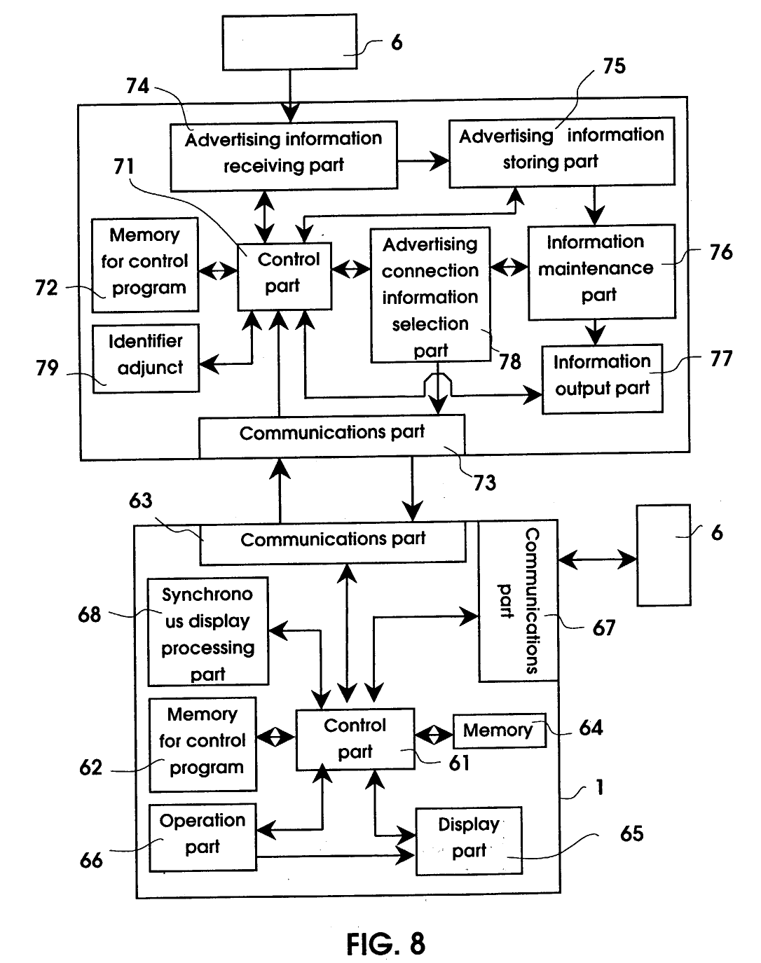

FIG. 8 is a view showing the interior constitution of the communication terminal 1 and the information providing device 2. The communication terminal 1 comprises a control part 61, a control program memory 62, a communications part 63, memory 64, a display part 65, an operation part 66, a communications part 67, and a synchronous display processing part 68. The constitutions thereof comprise combinations of hardware and software. However, constitutions comprised of hardware alone or of software alone may also be employed.

A control part 61, a control program memory 62, and an operation memory 66, and the functions thereof, correspond respectively to the control part 11, the control program memory 12, and the operation part 16 described with reference to the first embodiment. Accordingly, descriptions thereof will not be repeated but are instead incorporated by reference to the description of FIG. 4.

The communications part 63 serves as advertisement connection information acquisition command transmission means for transmitting a command for advertisement connection information acquisition to the information providing device 2 so that the receiver may acquire the URL 60 for the advertising information 5, and as a component for receiving the URL 60 of the favored advertising information 5 from the information providing device 2. The memory 64 is a component for storing the URL 60 received from the information providing device 2 and the advertising information 5 received from the management server 6. The display part 65 is a component for displaying the URL 60 and advertising information 5 in accordance with an operation performed by the receiver.

The communications part 67 is a component for performing data transmission and reception with the management server 6 via the Internet 7, and also serves as identifier-added advertisement connection information transmission means for transmitting identifier-added advertisement connection information to the management server 6. The synchronous display processing part 68 is a component for displaying advertising information 5 downloaded from the management server 6 in synchronization with advertising information 5 displayed on the information providing device 2. More specifically, the reproduction time of a predetermined data packet of advertising information 5 which has been divided into data packets is aligned with the reproduction time of an identical data packet in the information providing device 2, whereupon this data packet reproduction time is transmitted along with the advertising information 5.

The information providing device 2, meanwhile, comprises a control part 71, a control program memory 72, a communications part 73, an advertising information receiving part 74, an advertising information storing part 75, an information holding part 76, an information output part 77, an advertisement connection information selection part 78, and an identifier adjunct 79. The constitutions thereof comprise combinations of hardware and software. However, constitutions comprised of hardware alone or of software alone may also be employed.

The control part 71 and control program memory 72 and the functions thereof correspond respectively to the control part 21 and control program memory 22 described in the first embodiment, and hence descriptions thereof have been omitted.

The communications part 73 doubles as a component for receiving commands for advertisement connection information acquisition from the communication terminal 1 and advertisement connection information transmission means for transmitting a URL 60 for which an acquisition request has been placed to the communication terminal 1. The advertising information receiving part 74 is a component for receiving advertising information 5 from the management server 6. The system of reception may be either wireless or wired. Either an infrared two-way communications system or an electromagnetic induction system may be employed to perform data communications between the communications part 73 and the communications part 63 of the communication terminal 1. A communication method other than the above, for example a communication method using radio waves, may also be employed.

The advertising information storing part 75 is a component for storing advertising information 5 received from the management server 6. The information holding part 76 serves as advertisement connection information holding means for acquiring a URL 60 which serves as advertisement connection information for making a connection to advertising information 5 and holding this URL 60 such that it may be transmitted outside. The information output part 77 is a component for outputting the advertising information 5 as projected images and sound, and is constituted by a display part and speakers. Note, however, that the information output part 77 may be constituted by a display part or speakers alone. The advertisement connection information selection part 78 serves as advertisement connection information acquisition means for acquiring a URL 60 on the basis of an advertisement connection information acquisition command and transmitting the URL 60 to the communications part 73. The identifier adjunct 79 serves as identifier attaching means for attaching an identifier to the URL 60 which accords with the installation location of the corresponding information providing device 2.

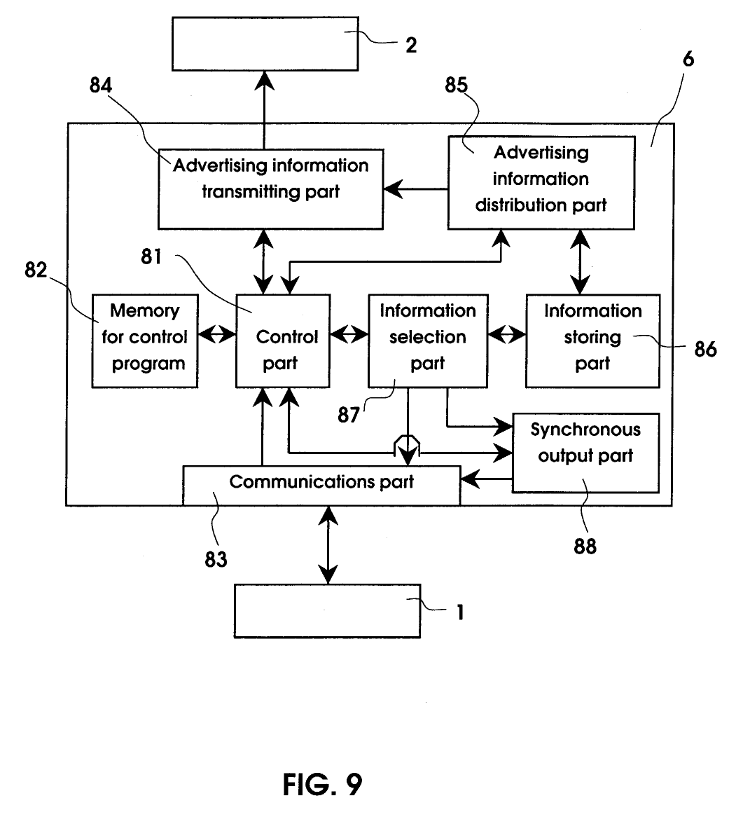

FIG. 9 is a view showing the structural configuration of the management server 6. The management server 6 comprises a control part 81, a control program memory 82, a communications part 83, an advertising information transmitting part 84, an advertising information distribution part 85, an information storing part 86, an information selection part 87, and a synchronous output part 88. The constitutions thereof comprise combinations of hardware and software. However, constitutions comprised of hardware alone or of software alone may also be employed.

The control part 81 is a component for controlling the processing of the management server 6. The control program memory 82 is a memory for storing a control program for the control part 81. The control part 81 executes various types of control on the basis of the program stored in the control program memory 82.

The communications part 83 serves as a component for performing data transmission and reception with the communication terminal 1 via the Internet 7, and also serves as advertising information transmission means capable of transmitting advertising information 5 to the communication terminal 1. The advertising information transmitting part 84 is a component for transmitting advertising information 5 to the information providing device 2 via the Internet 7. The advertising information distribution part 85 is a component for distributing advertising information 5 which is to be transmitted in accordance with the location of installation of the information providing device 2. The advertising information distribution part 85 is provided with a data table for verifying the installation location and the advertising information 5, and performs the distribution operation by referencing this data table. The management server 6 may also be provided with identifier attaching means.

The information storing part 86 is a component for storing advertising information 5. Besides advertising information 5, musical information linked to a URL or Web site data which are included in the advertising information 5 may also be stored in the information storing part 86. The information selection part 87 serves as advertising information 5 specification means for specifying the location of an information providing device 2 and information such as advertising information 5 (including musical information, Web site data and the like) on the basis of identifier-added advertisement connection information received from the communications terminal 1 and transmitting this specified advertising information 5 to the communications part 83.

The synchronous output part 88 is a component which is capable of attaching an advertising information 5 reproduction start time to the advertising information 5 and transmitting this advertising information 5 such that the advertising information 5 transmitted to the communication terminal 1 may be displayed in synchronization with the advertising information 5 displayed on the information providing device 2. Synchronous reproduction of the advertising information 5 is made possible by synchronizing the reproduction start time of a predetermined packet from among a plurality of data packets into which the advertising information 5 has been divided on the basis of the elapse of time following the start time of display with the reproduction start time of a predetermined packet of the advertising information 5 which is reproduced on the information providing device 2. Note that musical information may also be transmitted to the communication terminal 1 in synchronization with musical information transmitted to the information providing device 2.

Instead of having the management server 6 transmit advertising information 5 on the basis of access from the communication terminal 1, an advertisement distribution server other than the management server 6 may be provided such that when the management server 6 is accessed from the communication terminal 1, the management server 6 transmits a command to the advertisement distribution server to transmit the advertising information 5, in response to which the advertising information 5 is transmitted to the communication terminal 1 from the advertisement distribution server.

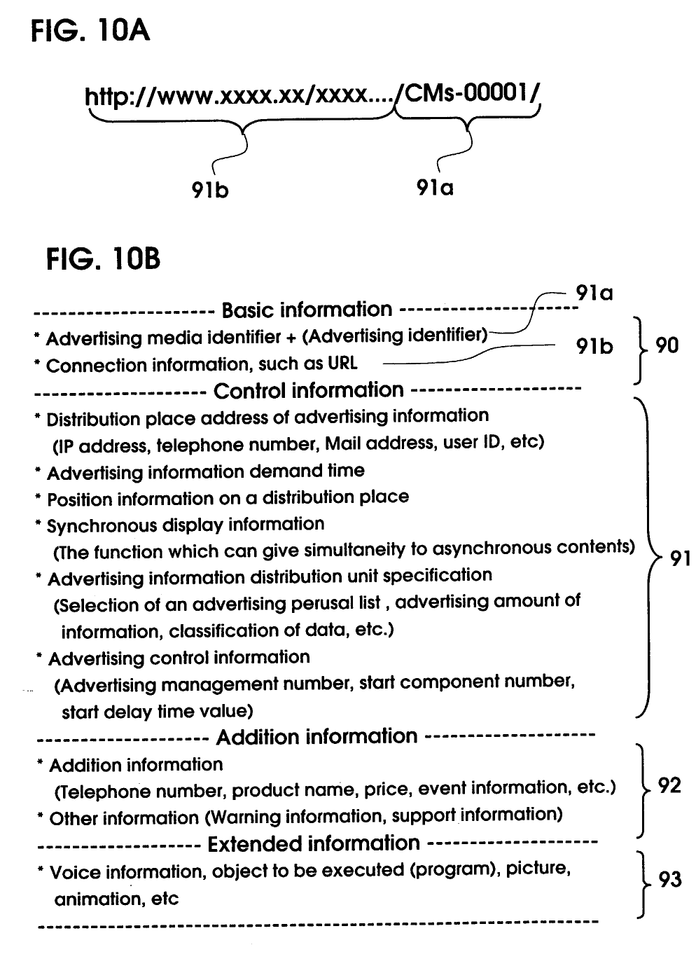

FIGS. 10A and 10B illustrate the structure of the URL 60 and the content of the advertising information 5. The URL 60 shown in FIG. 10A serves as the advertisement connection information. It includes an advertising medium identifier 91a and connection information 91b. Hence the information providing device 2 can be specified on the basis of this advertising medium identifier 91a. Note that a magic code may also be used as the advertising medium identifier 91a.

With reference to FIG. 10B, the advertising information 5 comprises basic information 90, control information 91, additional information 92, and extended information 93. The basic information 90 is advertisement connection information comprised of the advertising medium identifier 91a and the connection information 91b. Note that an advertisement identifier for specifying the advertising information 5 to be reproduced may be added to the advertising medium identifier 91a. The advertising medium identifier 91a may also comprise an advertisement identifier alone.

In this embodiment, the separate holding of the advertising information 5 and advertisement connection information in the information providing device 2 and the so-called synchronous acquisition may be performed in the same manner as the first embodiment.

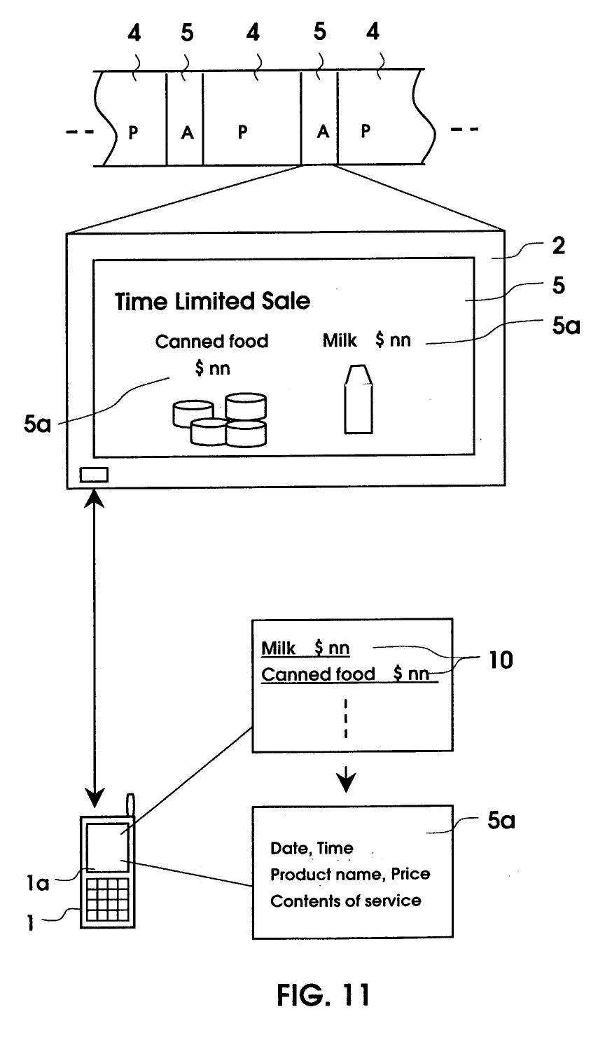

FIG. 11 is a view for explaining an application of the first embodiment. The information providing device 2 is disposed inside a supermarket and normally displays main program information 4 such as a store guide. At predetermined times, however, advertising information 5 such as a new product on sale or a product which has sold out is displayed. A customer (receiver) inside the store uses his/her communication terminal 1 to perform communications with the information providing device 2, thereby receiving title information (advertisement connection information) which is linked to product information 5a serving as a subordinate part of the advertising information 5.

The receiver selects a desired title 10 from the titles 10 displayed on the display part 1a of the communication terminal 1, and thereby receives the product information 5a (one aspect of the advertising information) which is linked to that title 10 from the information providing device 2.

Note, however, that instead of going through a two-step process of acquiring title information and then product information 5a, the communication between the communication terminal 1 and the information providing device 2 may be set as a one-step process wherein the advertising information 5 itself or the product information 5a is received directly. This is particularly appropriate for a case in which there is only one piece of product information 5a.

According to the present invention, advertising information is made more easily available to consumers, and as a result the advertising business can be expanded.

We claim:

1. An information transceiving system, comprising:
a communication terminal for receiving advertisement connection information to be used by a receiver to make a connection to advertising information;
an information providing device capable of providing the advertising information;
advertisement connection memory means for storing advertisement connection information in said communication terminal;
advertisement connection information acquisition command transmission means for transmitting a command for advertisement connection information acquisition to said information providing device in order to acquire one or more pieces of the advertisement connection information;
advertisement connection information acquisition means for acquiring one or more pieces of the advertisement connection information on the basis of the command for advertisement connection information acquisition from said communication terminal; and
advertisement connection information transmission means for transmitting the acquired advertisement connection information to said communication terminal.

2. The information transceiving system according to claim 1, which further comprises:
advertising information memory means for storing the advertising information;
advertising information acquisition command transmission means for transmitting a command for advertising information acquisition to said information providing device in order to acquire advertising information relating to one or more pieces of the advertisement connection information;
advertising information acquisition means for acquiring advertising information relating to the command for advertising information acquisition; and
advertising information transmission means for transmitting the acquired advertising information to said communication terminal.

3. The information transceiving system according to claim 1, wherein:
the advertisement connection information is included in the advertising information provided by said information providing device; and
said advertisement connection information holding means are adapted to extract the advertisement connection information from the advertising information and to store the advertisement connection information separately from the advertising information.

4. The information transceiving system according to claim 1, wherein said advertisement connection information acquisition means enable the advertisement connection information to be acquired on condition that the command for advertisement connection information acquisition is received within a predetermined time period including the time period during which said information providing device provides the advertisement connection information.

5. The information transceiving system according to claim 1, wherein the advertisement connection information includes a URL addressing a location at which the advertising information is stored.

6. An information transceiving system, comprising:
a communication terminal for receiving connection information to be used by a receiver to make a connection for retrieving information, said communication terminal including a connection memory device configured to store the connection information in said communication terminal;
an information providing device capable of providing the information;
a connection information acquisition command transmitter connected to said communication terminal and configured to transmit a command for connection information acquisition to said information providing device in order to acquire one or more pieces of the connection information;
a connection information acquisition device configured to acquire one or more pieces of the connection information on the basis of the command for connection information acquisition; and
a connection information transmitter configured to transmit the acquired connection information to said communication terminal.

7. An information transceiving system, comprising:
a communication terminal for receiving advertisement connection information used by a receiver to make a connection to advertising information;
an information providing device enabled to provide the advertising information; and
a management server for managing the advertising information or information relating to the advertising information;
identifier attaching means for creating identifier-added advertisement connection information by attaching to the advertisement connection information an identifier uniquely identifying a location of said information providing device;
advertisement connection information memory means for transmittably storing the identifier-added advertisement connection information;
advertisement connection information acquisition command transmission means for transmitting a command for advertisement connection information acquisition to said information providing device in order to acquire one or more pieces of the identifier-added advertisement connection information;
advertisement connection information acquisition means for acquiring one or more pieces of the identifier-added advertisement connection information on the basis of the command for advertisement connection information acquisition from said communication terminal; and
advertisement connection information transmission means for transmitting the acquired identifier-added advertisement connection information to said communication terminal.

8. The information transceiving system according to claim 7, which further comprises:
identifier-added advertisement connection information transmission means for transmitting the identifier-added advertisement connection information from said communication terminal to said management server;
advertising information specifying means for specifying advertising information relating to the location of said advertisement connection information based on the identifier-added advertisement connection information; and
advertising information transmission means for transmitting the specified advertising information to said communication terminal.

9. The information transceiving system according to claim 8, wherein said advertising information transmission means are configured to transmit the advertising information and information concerning a reproduction start time of the advertising information to said communication terminal.

10. The information transceiving system according to claim 7, wherein:
the identifier-added advertisement connection information is included in the advertising information provided by said information providing device; and
said advertisement connection information memory means are adapted to extract the identifier-added advertisement connection information from the advertising information and to store the identifier-added advertisement connection information separately from the advertising information.

11. The information transceiving system according to claim 7, wherein said advertisement connection information acquisition means enable the advertisement connection information to be acquired on condition that the command for advertisement connection information acquisition is received within a predetermined time period including a time period during which said information providing device provides the advertisement connection information.

12. The information transceiving system according to claim 7, wherein the advertisement connection information includes a URL addressing a location at which the advertising information is stored.

13. The information transceiving system according to claim 7, wherein said management server stores a database including at least transmission processing information concerning the advertising information.

14. The information transceiving system according to claim 13, wherein said management server is adapted to store the advertising information.

15. An information transceiving system, comprising:
a communication terminal for receiving connection information used by a receiver to make a connection to acquire information content;
an information providing device enabled to provide the information content;
a management server for managing the information content or information relating to the information content;
a device configured to attach an identifier for creating identifier-added connection information by attaching to the connection information an identifier uniquely identifying a location of said information providing device;
a memory device for storing the identifier-added connection information with the added identifier;
a transmitter for transmitting a connection information acquisition command to said information providing device to acquire at least a portion of the identifier-added connection information;
an acquisition device for acquiring at least a portion of the identifier-added connection information on a basis of the command for connection information acquisition from said communication terminal; and
a transmitter configured to transmit the acquired identifier-added advertisement connection information to said communication terminal.
